(19) United States
(12) Patent Application Publication
(10) Pub. No.: US 2026/0148532 A1
(43) Pub. Date: May 28, 2026

(54) ENHANCING PHYSICAL REASONING IN VISION-LANGUAGE MODELS USING SPECIALIZED CONTEXT BUILDER MODULES

(71) Applicant: AUTODESK, INC., San Francisco, CA (US)

(72) Inventors: Mohammadmehdi ATAEI, Toronto (CA); Vahid Balazadeh MERESHT, Toronto (CA); Hyunmin CHEONG, Toronto (CA); Amir Hosein KHAS AHMADI, Toronto (CA)

(21) Appl. No.: 19/402,730

(22) Filed: Nov. 26, 2025

Related U.S. Application Data
(60) Provisional application No. 63/726,125, filed on Nov. 27, 2024.

(51) Int. Cl. G06V 10/774; G06N 20/00

(52) U.S. Cl. CPC G06V 10/774; G06N 20/00

(57) ABSTRACT

One embodiment sets forth a technique for generating training data for physical reasoning models. According to some embodiments, the technique can include the steps of obtaining simulation annotations generated by a physics-based simulation environment for a plurality of simulated scenes; generating a plurality of scene descriptions based on the simulation annotations; generating a training dataset by combining the plurality of scene descriptions with corresponding visual data depicting the plurality of simulated scenes; and training at least one physical reasoning model using the training dataset to generate at least one trained physical reasoning model.

### CROSS-REFERENCE TO RELATED APPLICATIONS

This application claims benefit of the United States Provisional Patent Application titled “TECHNIQUES FOR ENHANCING PHYSICAL REASONING IN VISION-LANGUAGE MODELS USING PROCEDURAL SYNTHETIC DATA GENERATION AND SPECIALIZED CONTEXT BUILDER MODULES,” filed November 27, 2024, and having serial number 63/726,125. The subject matter of this related application is hereby incorporated herein by reference.

### BACKGROUND

### Field of the Various Embodiments

The present disclosure relates generally to physics simulations, computer science, artificial intelligence, and complex software applications, and, more specifically, enhancing physical reasoning in vision-language models using procedural synthetic data generation and specialized context builder modules.

### Description of the Related Art

Physical reasoning constitutes a fundamental aspect of human cognition that enables interpretation of object behaviors, prediction of physical interactions, and understanding of causal relationships in dynamic environments. Physical reasoning encompasses the ability to assess spatial relationships between objects, predict future states of physical systems, and understand causal relationships between physical interactions. Although intuitive to humans, physical reasoning presents a significant challenge for automated systems, including artificial intelligence systems. Accurate physical reasoning is essential for any application in which an artificial intelligence system interacts with the physical world. Such applications include robotics, automated vehicles, and mechanical system design.

Recent breakthroughs with transformer architecture machine learning models have enabled the processing of physical scenes from images and videos. Conventional vision-language models (VLMs) represent large machine learning models capable of understanding both visual and textual information simultaneously through a combination of image and text encoders. VLMs are trained on large-scale datasets comprising images with corresponding captions or videos consisting of multiple image frames with corresponding scene descriptions. VLMs excel at descriptive tasks that provide high-level descriptions of properties associated with image or video content, such as scene descriptions and object identification.

One technical drawback of conventional vision-language models involves limited capability with complex physical reasoning tasks. Despite strong capabilities with descriptive tasks, VLMs encounter difficulties with more complex physical reasoning tasks that require reasoning beyond mere observation of physical features. Examples of such tasks include object stability, collision predictions, and causal effects. In some cases, VLMs struggle to accurately describe presented scenes in detail beyond a high-level description. Additionally, even with an accurate assessment of the current state of a visual system, additional reasoning power becomes necessary to predict future states of the system or imagine counterfactual examples. Such shortcomings limit the utility of VLMs in applications where high-level physical reasoning is essential.

Another technical drawback of conventional vision-language models involves the challenges associated with fine-tuning existing models for physical reasoning tasks. Fine-tuning existing VLM models is challenging for multiple reasons. Existing datasets for training VLMs consist primarily of image captions and video scene descriptions. Therefore, VLM models trained on such datasets excel in generating captions and descriptions. New datasets would need to be generated to fine-tune models for physical reasoning tasks that require detailed descriptions of scenes from simulations. Such descriptions must simultaneously describe precisely the exact positions and interactions of all objects in the scene. Additionally, detailed scene data must be presented in a natural language format acceptable to VLMs. Generating such a dataset presents a technical challenge. Furthermore, fine-tuning large VLMs is computationally costly and impractical. Fine-tuning a model to each type of reasoning problem the model may confront is desirable for many physical reasoning tasks. For instance, a VLM may be fine-tuned to handle stability assessment tasks, while another VLM may be fine-tuned to anticipate collisions. Fine-tuning separate large models for each task is prohibitively costly, but one single fine-tuned physical reasoning model may not be capable of solving all necessary tasks.

As the foregoing illustrates, what is needed in the art are more effective techniques for training video-language models for physical reasoning tasks.

### SUMMARY

One embodiment sets forth a technique for generating training data for physical reasoning models. According to some embodiments, the technique can include the steps of obtaining simulation annotations generated by a physics-based simulation environment for a plurality of simulated scenes; generating a plurality of scene descriptions based on the simulation annotations; generating a training dataset by combining the plurality of scene descriptions with corresponding visual data depicting the plurality of simulated scenes; and training at least one physical reasoning model using the training dataset to generate at least one trained physical reasoning model.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques over the prior art is that the disclosed techniques enable accurate physical reasoning in visual-language models by separating visual perception from reasoning. The disclosed techniques train specialized physics context builder (PCB) models, which generate detailed physical scene descriptions from visual inputs. PCB models are smaller vision-language models that are fine-tuned on simulation data. PCB models fine-tuned on simulation data are capable of generating comprehensive descriptions of physical properties and spatial relationships in visual scenes. These comprehensive descriptions enable large reasoning models to perform physical reasoning from enriched text descriptions rather than extracting complex physical relationships directly from visual data. By separating the visual description from physical reasoning, PCBs enable large-scale reasoning models to achieve improved physical reasoning performance.

Another technical advantage of the disclosed techniques over the prior art is that the disclosed techniques provide a data generation procedure that generates training datasets for physical reasoning tasks. The disclosed techniques use physics simulation environments to generate synthetic scenes along with precise natural language annotations of object positions and velocities. Extraction of such elements is not possible from real-world videos. Such physical reasoning datasets are useful for fine-tuning existing visual-language models to achieve better performance on physical reasoning tasks. Additionally, such physical reasoning datasets may also be used to train PCBs to produce detailed scene descriptions from visual inputs.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a block diagram illustrating the machine learning server of FIG. 1 in greater detail, according to various embodiments.

FIG. 3 is a conceptual illustration of an architecture and an informational flow that can be implemented by the detailed description generator of FIG. 1, according to various embodiments.

FIG. 4 is a conceptual illustration of an architecture and an informational flow that can be implemented by the model trainer of FIG. 1, according to various embodiments.

FIG. 5 is a conceptual illustration of an architecture and an informational flow that can be implemented by a multi-agent PCB framework, according to various embodiments.

FIG. 6 illustrates a method for generating a detailed description example fine-tuning training set, according to various embodiments.

FIG. 7 illustrates a method for implementing a multi-agent PCB framework for physical reasoning tasks, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

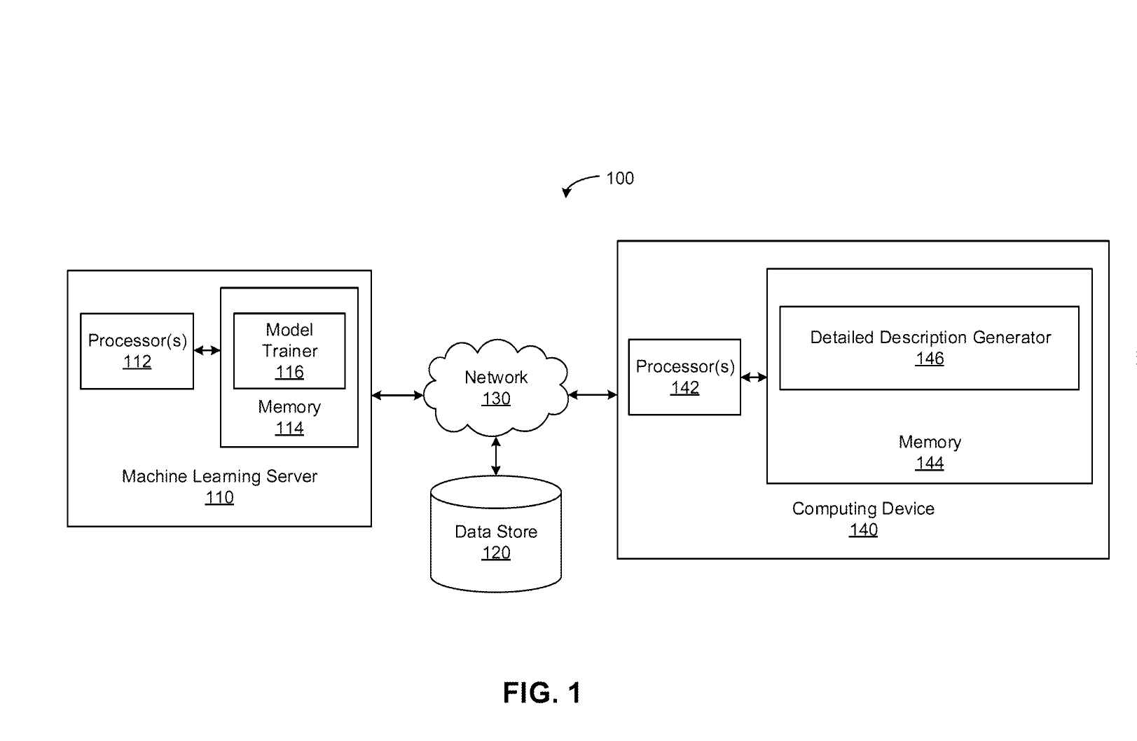

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130. The network 130 can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, which control and coordinate operations of other system components. In particular, the processor(s) 112 can issue commands that control the operation of one or more graphics processing units (GPUs) (not shown) and/or other parallel processing circuitry, such as parallel processing units or deep learning accelerators, that incorporate circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment. Such an environment can be a public, private, or a hybrid cloud system.

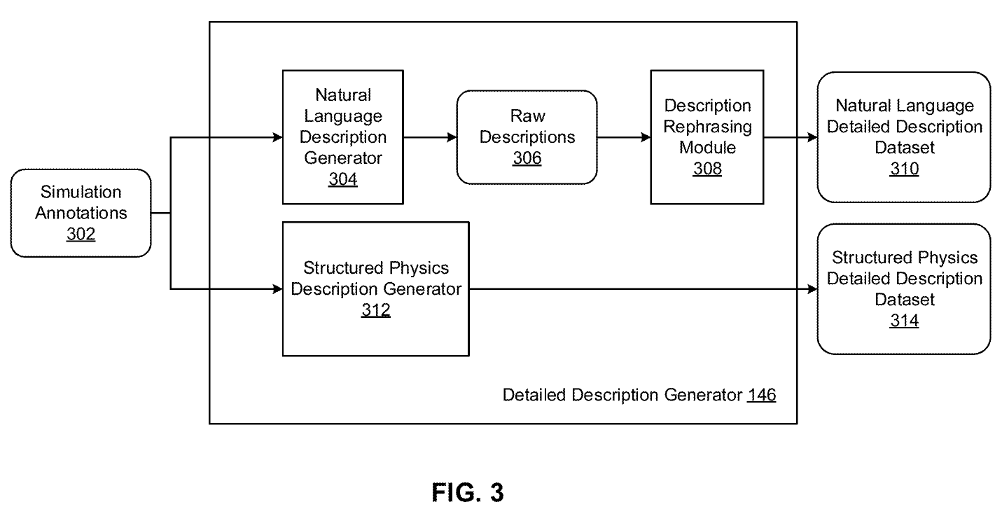

In some embodiments, the model trainer 116 is configured to train one or more machine learning models, including a fine-tuned PCB model 408. Techniques that the model trainer 116 can use to train the machine learning model(s) are discussed in greater detail below in conjunction with FIGS. 3-7. Training data and/or trained (or deployed) machine learning models can be stored in the data store 120. In some embodiments, the data store 120 can include any storage device or devices, such as fixed disc drives, flash drives, optical storage, network-attached storage (NAS), and/or a storage area network (SAN). Although shown as accessible over the network 130, in at least one embodiment, the machine learning server 110 can include the data store 120.

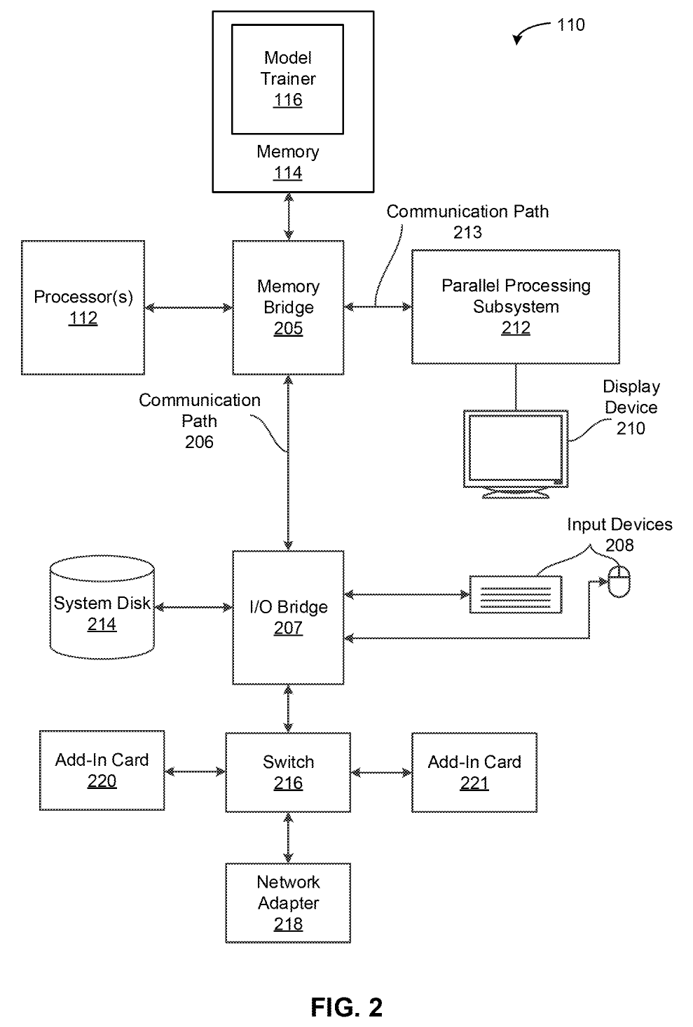

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a handheld/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory(IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (SoC).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In some embodiments, one or more components shown in FIG. 2 may not be present. For example, switch 216 could be eliminated, and network adapter 218 and add-in cards 220, 221 would connect directly to I/O bridge 207. Lastly, in some embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Training Physics Context Builder Models

FIG. 3 provides a detailed illustration of the detailed description generator 146 described in conjunction with FIG. 1, according to various embodiments. As shown in FIG. 3, the detailed description generator 146 includes a natural description generator 304, a description rephrasing module 308, and a structured physics description generator 312. The detailed description generator 146 receives the simulation annotations 302 as input and generates the natural language detailed description dataset 310 and the structured physics detailed description dataset 314 as outputs.

The simulation annotations 302 consist of structured data output by a physics simulation environment that executed a simulation of a physical scene. The simulation annotations 302 include object identifiers, object properties, and spatial information, as well as object positions over multiple time intervals. For example, in some embodiments, the simulation annotations 302 include the shape and color of various objects, as well as object positions and velocities at various points in time in the simulation. The simulation annotations 302 are generated by physical simulation software that realistically simulates the motions and interactions of objects of various types in a scene. The simulation annotations 302 are formatted as structured data that can be parsed by the detailed description generator 146, such as JSON or XML.

The natural language description generator 304 receives the simulation annotations 302 as input and generates the raw descriptions 306 as output. The natural language description generator 304 converts the simulation annotations 302 into narrative, natural-language descriptions of the scene. The natural language description generator 304 identifies and describes all objects in the scene and describes the evolution of key events in the scene, such as object collisions and objects entering or exiting the field of view. In some embodiments, the natural language description generator 304 deterministically generates the natural language description by iterating through the objects and events detailed in the simulation annotations 302 and populating template strings with relevant information from the scene. The natural language description generator 304 outputs the generated narrative descriptions as the raw descriptions 306.

The description rephrasing module 308 receives the raw descriptions 306 as input and generates the natural language detailed description dataset 310 as output. The description rephrasing module 308 refines and rephrases the raw descriptions 306 to improve clarity and introduce more variance in the description forms, thereby ensuring that none of the factual content of the description changes. In some embodiments, a large language model is used to rephrase the raw descriptions 306 to describe the scenes using different phrasings and structures. After the rephrasing operation, the rephrased descriptions are returned as the natural language detailed description dataset 310. In other embodiments, no rephrasing is performed on the raw descriptions 306, and the raw descriptions 306 are returned as the natural language detailed description dataset 310. The natural language detailed description dataset 310 describes each scene detailed by simulation annotations 302 using a narrative, natural language format that is compatible with visual-language models.

The structured physics description generator 312 receives the simulation annotations 302 as input and generates the structured physics detailed description dataset 314 as output. The structured physics description generator 312 converts the simulation annotations 302 into standardized descriptions using tags, labels, and other standardized formatting tools. The structured physics description generator 312 formats the physical properties of the simulation annotations 302 to create frame-by-frame detailed annotations that list the exact properties and descriptions of each object in the frame. In some embodiments, the structured physics description generator 312 deterministically generates the standardized descriptions by populating templates with the properties described in the simulation annotations 302. The resulting structured physics detailed description dataset 314 describes the scene in detail without the use of natural language, instead listing frame-by-frame exact locations and properties of all objects in the scene in detail.

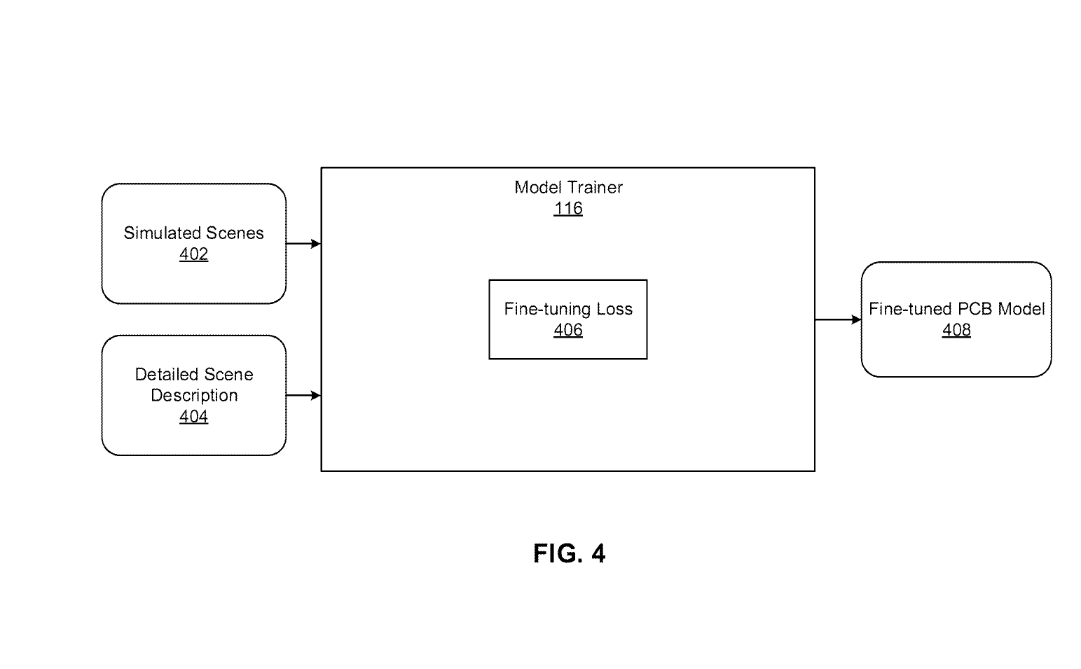

FIG. 4 provides a detailed illustration of a physics context builder model training system described in conjunction with FIGS. 1-6, according to various embodiments. As shown in FIG. 4, the physics context builder training system includes the model trainer 116 and a fine-tuning loss 406. The model trainer 116 receives the simulated scenes 402 and a detailed scene description 404 as inputs and generates the fine-tuned PCB model 408 as output.

The simulated scenes 402 consist of visual data, including images or videos, generated by a physics simulation environment. The simulated scenes 402 show physical scenes with objects interacting with realistic physics. Each visual data instance in the simulated scenes 402 corresponds to one or more training samples in the detailed scene description 404.

The detailed scene descriptions 404 consist of detailed descriptions of the simulated scenes 402. The detailed scene description 404 includes a description of all objects in the scene, including object properties, locations, and scene evolution through time. In some embodiments, the detailed scene descriptions 404 are generated by the detailed description generator 146, as described in conjunction with FIG. 3. In some embodiments, the detailed scene description 404 comprises the natural language detailed description dataset 310, where descriptions are formatted as natural language narratives. In other embodiments, the detailed scene descriptions 404 comprise the structured physics detailed description dataset 314, where descriptions are formatted with standardized formats describing the scene in frame-level detail.

The model trainer 116 receives the simulated scenes 402 and the detailed scene description 404 as inputs and performs a fine-tuning procedure to optimize a pre-trained vision-language model to function as a physics context builder. The model trainer 116 provides the visual data of the simulated scenes 402 as input and trains the model to generate scene descriptions that match the detailed scene descriptions 404. The fine-tuning loss 406 quantifies the discrepancy between the generated descriptions and the scene descriptions 404 and backpropagates changes to the fine-tuning parameters to minimize the fine-tuning loss 406. The model trainer 116 executes the training procedure until convergence has been achieved and returns the fine-tuned PCB model 408.

The fine-tuned PCB model 408 includes a fine-tuned vision-language model optimized to generate detailed scene descriptions from an image or video of a given scene. The generated descriptions summarize physical properties and events of a given scene to a high degree of detail and accuracy.

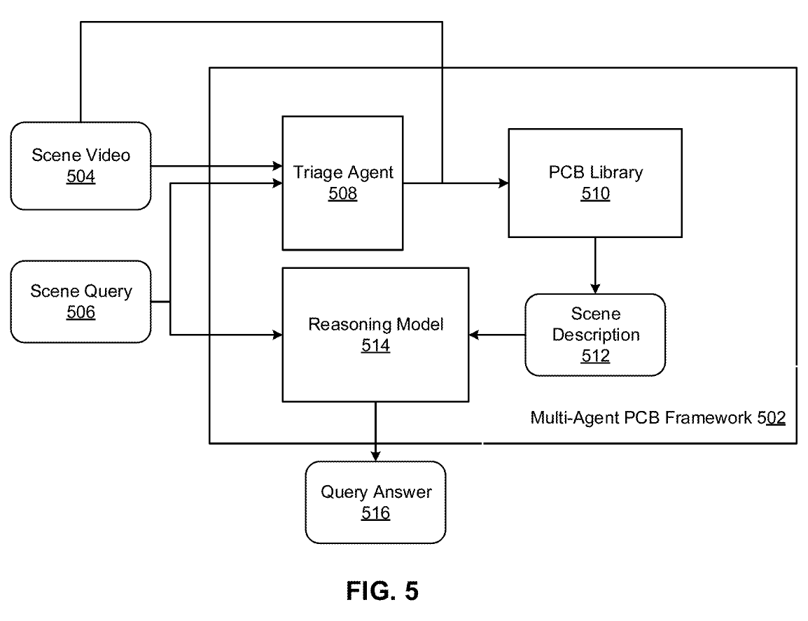

FIG. 5 provides a detailed illustration of a multi-agent PCB framework 502 for enhanced physical reasoning, according to various embodiments. As shown in FIG. 5, the multi-agent PCB framework 502 includes a triage agent 508, a PCB library 510, and a reasoning model 514. The multi-agent PCB framework 502 receives a scene video 504 and a scene query 506 as inputs and generates a query answer 516 as output.

The scene video 504 consists of visual data that shows a scene for which physical reasoning is required. The scene video 504 includes images or video that show objects arranged in a scene, possibly undergoing interactions. The scene query 506 consists of a natural language question about the scene shown in the scene video 504. For example, in some embodiments, the scene query 506 may ask about the color of a certain object in the scene, whether a structure is stable, or whether two objects in a scene will collide.

The triage agent 508 receives the scene video 504 and the scene query 506 as inputs and analyzes the inputs to determine the type of physical reasoning required. The triage agent 508 analyzes both the scene video 504 and the scene query 506 to determine which of the PCB models in the PCB library 510 is best suited for the given task. The triage agent 508 selects the most appropriate PCB model from the PCB library 510 and passes the scene video 504 to the selected model to describe.

The PCB library 510 consists of a collection of physics context builder models, where each PCB model is optimized to generate detailed descriptions of specific types of scenes or descriptions suited for specific reasoning tasks. For example, in some embodiments, the PCB library 510 will include a PCB model specialized for stability assessment and a PCB model for scenes with many objects. In some embodiments, the PCB library 510 consists of only a single PCB model fine-tuned for general physical reasoning tasks. In this embodiment, the triage agent trivially selects the PCB model in the PCB library 510 to describe the scene video 504. Each PCB model in the PCB library 510 corresponds to a fine-tuned PCB model 408 as described in conjunction with FIG. 4. During inference, the triage agent 508 selects which PCB model in the PCB library 510 is best suited for the given scene video 504 and scene query 506 and passes the scene video 504 to the selected PCB model. The selected PCB model accepts the scene video 504 as input and produces the scene description 512 as output.

The reasoning model 514 receives the scene query 506 and scene description 512 as input and generates the query answer 516 as output. The reasoning model 514 comprises a large-scale foundation model capable of performing reasoning tasks. The reasoning model 514 processes the scene description 512 as additional context and determines the answer of the scene query 506 using the information provided. In some embodiments, the reasoning model 514 is a visual language model capable of accepting both visual and text inputs. In this embodiment, the reasoning model 514 may also accept the scene video 504 as input along with the scene description 512 and use both inputs as context to answer the scene query 506. After performing the relevant reasoning to determine the answer to scene query 506, the reasoning model 514 returns the query answer 516.

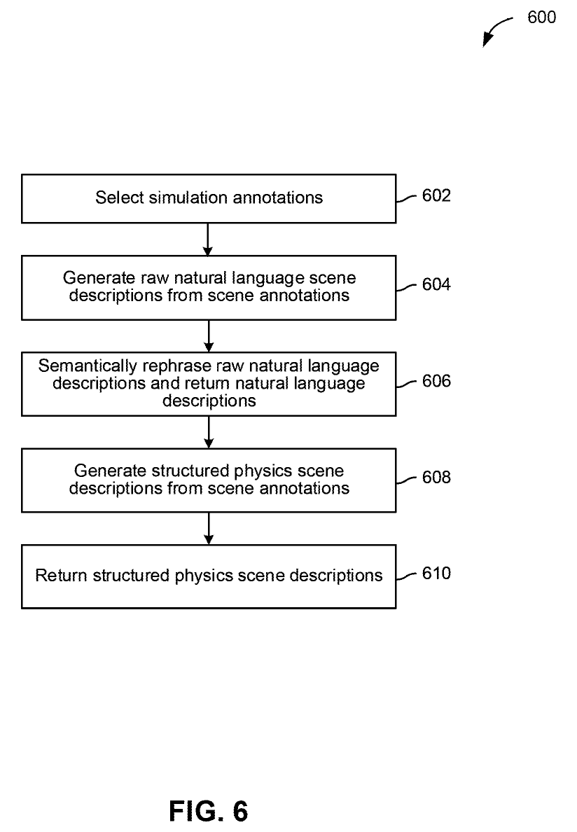

FIG. 6 sets forth a flow diagram of method steps for generating detailed physical scene descriptions from physics simulation annotations, according to various embodiments. Although the method steps are described in conjunction with the systems of FIGS. 1-5, persons skilled in the art will understand that any system configured to perform the method steps in any order falls within the scope of the present disclosure.

As shown, method 600 begins at step 602, where the detailed description generator 146 selects simulation annotations 302. The simulation annotations 302 include structured data generated by a physics simulation environment, which encompasses object properties, spatial orientation, and temporal evolution. The simulation annotations 302 are processed through two parallel pathways to generate two different formats of detailed scene descriptions.

At step 604, the natural language description generator 304 generates raw natural language scene descriptions from the simulation annotations 302. The natural language description generator 304 converts the simulation annotations 302 into narrative descriptions of the physical scene in natural language format. The natural language description generator 304 constructs descriptions of all objects in the scene and the time evolution of the objects and their interactions throughout the scene to generate the raw descriptions 306.

At step 606, the description rephrasing module 308 semantically rephrases the raw descriptions 306 into natural language descriptions. The description rephrasing module 308 refines and rephrases the raw descriptions 306 to improve clarity and introduce variance, thereby ensuring factual information remains intact. Such rephrased descriptions are returned as the natural language detailed description dataset 310.

At step 608, the structured physics description generator 312 generates structured physics scene descriptions from the simulation annotations 302. The structured physics description generator 312 converts the simulation annotations 302 into detailed, frame-by-frame descriptions of the scene using standardized tags. Such structured physics scene descriptions include detailed descriptions of all object positions, properties, and movement at each frame of the scene.

At step 610, the structured physics description generator 312 returns the structured physics scene descriptions as the structured physics detailed description dataset 314.

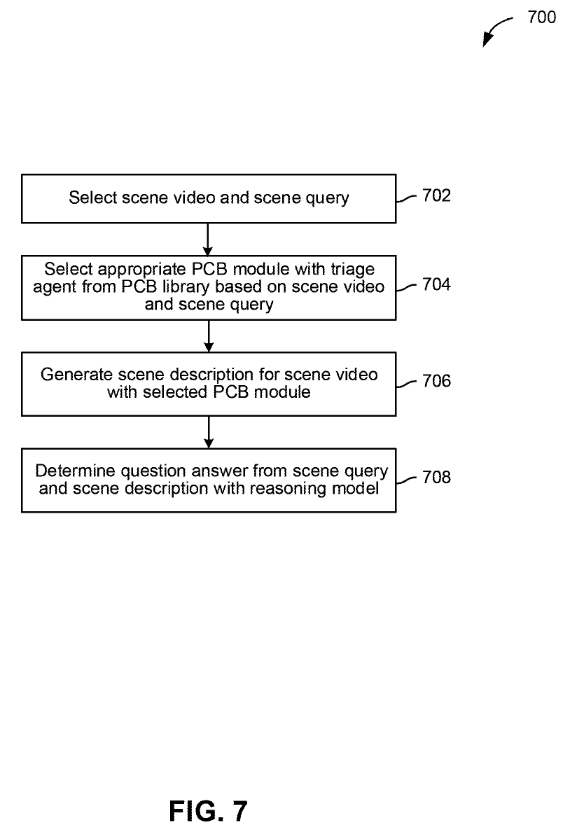

FIG. 7 sets forth a flow diagram of method steps for performing physical reasoning using the multi-agent PCB framework, according to various embodiments. Although the method steps are described in conjunction with the systems of FIGS. 1-6, persons skilled in the art will understand that any system configured to perform the method steps in any order falls within the scope of the present disclosure.

As shown, method 700 begins at step 702, where the multi-agent PCB framework 502 selects a scene video 504 and a scene query 506. The scene video 504 consists of visual data showing a physical scene for which physical reasoning is required. The scene query 506 consists of a natural language question that queries an aspect of the scene shown in the scene video 504.

At step 704, the triage agent 508 analyzes the scene video 504 and the scene query 506 to determine which PCB model in the PCB library 510 is most applicable to the problem. The triage agent 508 identifies the appropriate specialized PCB model from the PCB library 510 that corresponds best to the scene video 504 and the scene query 506 and passes the scene video 504 to the selected PCB model to describe.

At step 706, the selected PCB module from the PCB library 510 generates a scene description 512 of the scene video 504. The selected PCB model processes the scene video 504 to describe the relevant physical properties, spatial relationships, and dynamics in the scene.

At step 708, the reasoning model 514 determines the query answer 516 from the scene query 506 and the scene description 512. The reasoning model 514 is a large-scale reasoning model that in some embodiments is a large language model or a large vision-language model. The reasoning model 514 uses the context provided by the scene description 512 to determine the answer to the scene query 506 and generate the query answer 516.

In sum, the disclosed techniques are directed toward implementing enhanced physical reasoning capabilities in vision-language models through simulation-based training data generation and modular inference architectures. More specifically, in various embodiments, the disclosed techniques include generating training data that comprises images and/or videos of physical scenes along with detailed annotations of object positions and velocities through simulation tools. In various embodiments, a data generation module receives the simulation annotations and converts such annotations into detailed natural-language descriptions of the corresponding scenes. Such natural-language descriptions, along with the corresponding scenes, are used to fine-tune a physics context builder (PCB) model to provide detailed descriptions of visual scenes. The PCB model is subsequently used to provide additional physics context for a large reasoning model to perform physical reasoning tasks.

At least one technical advantage of the disclosed techniques over the prior art is that the disclosed techniques enable accurate physical reasoning in visual-language models by separating visual perception from reasoning. The disclosed techniques train specialized physics context builder (PCB) models, which generate detailed physical scene descriptions from visual inputs. PCB models are smaller vision-language models that are fine-tuned on simulation data. PCB models fine-tuned on simulation data are capable of generating comprehensive descriptions of physical properties and spatial relationships in visual scenes. These comprehensive descriptions enable large reasoning models to perform physical reasoning from enriched text descriptions rather than extracting complex physical relationships directly from visual data. By separating the visual description from physical reasoning, PCBs enable large-scale reasoning models to achieve improved physical reasoning performance.

Another technical advantage of the disclosed techniques over the prior art is that the disclosed techniques provide a data generation procedure that generates training datasets for physical reasoning tasks. The disclosed techniques use physics simulation environments to generate synthetic scenes along with precise natural language annotations of object positions and velocities. Extraction of such elements is not possible from real-world videos. Such physical reasoning datasets are useful for fine-tuning existing visual-language models to achieve better performance on physical reasoning tasks. Additionally, such physical reasoning datasets may also be used to train PCBs to produce detailed scene descriptions from visual inputs.

1. In some embodiments, a computer-implemented method for generating training data for physical reasoning models comprises: obtaining simulation annotations generated by a physics-based simulation environment for a plurality of simulated scenes; generating a plurality of scene descriptions based on the simulation annotations; generating a training dataset by combining the plurality of scene descriptions with corresponding visual data depicting the plurality of simulated scenes; and training at least one physical reasoning model using the training dataset to generate at least one trained physical reasoning model.

2. The computer-implemented method of clause 1, wherein the simulation annotations comprise structured data that includes at least one of object identifiers, object properties, or temporal parameters associated with the plurality of simulated scenes.

3. The computer-implemented method of any of clauses 1-2, wherein generating the plurality of scene descriptions comprises generating natural-language descriptions from the simulation annotations.

4. The computer-implemented method of any of clauses 1-3, further comprising rephrasing the natural-language descriptions to generate alternative linguistic forms.

5. The computer-implemented method of any of clauses 1-4, wherein generating the plurality of scene descriptions comprises generating structured descriptions that specify scene content in a machine-readable format.

6. The computer-implemented method of any of clauses 1-5, wherein generating the training dataset comprises associating each scene description included in the plurality of scene descriptions with an image frame depicting a corresponding simulated scene included in the plurality of simulated scenes.

7. The computer-implemented method of any of clauses 1-6, wherein the training dataset includes both natural-language and structured descriptions corresponding to each simulated scene included in the plurality of simulated scenes.

8. The computer-implemented method of any of clauses 1-7, wherein the training dataset is formatted in a data structure compatible with a vision-language model.

9. The computer-implemented method of any of clauses 1-8, wherein the physics-based simulation environment simulates interactions among multiple objects governed by physical laws.

10. The computer-implemented method of any of clauses 1-9, wherein training the at least one physical reasoning model comprises fine-tuning a pre-trained vision-language model using the training dataset.

11. The computer-implemented method of any of clauses 1-10, wherein fine-tuning the pre-trained vision-language model comprises minimizing a loss function that quantifies a difference between model-generated scene descriptions and the plurality of scene descriptions associated with the training dataset.

12. In some embodiments, one or more non-transitory computer readable media store instructions that, when executed by one or more processors, cause the one or more processors to generate training data for physical reasoning models, by performing the operations of: obtaining simulation annotations generated by a physics-based simulation environment for a plurality of simulated scenes; generating a plurality of scene descriptions based on the simulation annotations; generating a training dataset by combining the plurality of scene descriptions with corresponding visual data depicting the plurality of simulated scenes; and training at least one physical reasoning model using the training dataset to generate at least one trained physical reasoning model.

13. The one or more non-transitory computer readable media of clause 12, wherein the at least one trained physical reasoning model is configured to generate physical reasoning outputs in response to visual inputs depicting real-world scenes.

14. The one or more non-transitory computer readable media of any of clauses 12-13, wherein the simulation annotations are generated automatically by executing scripted scenarios within the physics-based simulation environment.

15. The one or more non-transitory computer readable media of any of clauses 12-14, wherein the simulation annotations comprise structured data that includes at least one of object identifiers, object properties, or temporal parameters associated with the plurality of simulated scenes.

16. The one or more non-transitory computer readable media of any of clauses 12-15, wherein generating the plurality of scene descriptions comprises generating natural-language descriptions from the simulation annotations.

17. The one or more non-transitory computer readable media of any of clauses 12-16, further comprising rephrasing the natural-language descriptions to generate alternative linguistic forms.

18. The one or more non-transitory computer readable media of any of clauses 12-17, wherein generating the plurality of scene descriptions comprises generating structured descriptions that specify scene content in a machine-readable format.

19. The one or more non-transitory computer readable media of any of clauses 12-18, wherein generating the training dataset comprises associating each scene description included in the plurality of scene descriptions with an image frame depicting a corresponding simulated scene included in the plurality of simulated scenes.

20. In some embodiments, a computer system comprises one or more memories that include instructions, and one or more processors that are coupled to the one or more memories and that, when executing the instructions, are configured to generate training data for physical reasoning models, by performing the operations of: obtaining simulation annotations generated by a physics-based simulation environment for a plurality of simulated scenes; generating a plurality of scene descriptions based on the simulation annotations; generating a training dataset by combining the plurality of scene descriptions with corresponding visual data depicting the plurality of simulated scenes, and training at least one physical reasoning model using the training dataset to generate at least one trained physical reasoning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope there of, and the scope thereof is determined by the claims that follow.

What is claimed is:

1. A computer-implemented method for generating training data for physical reasoning models, the method comprising:
obtaining simulation annotations generated by a physics-based simulation environment for a plurality of simulated scenes;
generating a plurality of scene descriptions based on the simulation annotations;
generating a training dataset by combining the plurality of scene descriptions with corresponding visual data depicting the plurality of simulated scenes; and
training at least one physical reasoning model using the training dataset to generate at least one trained physical reasoning model.

2. The computer-implemented method of claim 1, wherein the simulation annotations comprise structured data that includes at least one of object identifiers, object properties, or temporal parameters associated with the plurality of simulated scenes.

3. The computer-implemented method of claim 1, wherein generating the plurality of scene descriptions comprises generating natural-language descriptions from the simulation annotations.

4. The computer-implemented method of claim 3, further comprising rephrasing the natural-language descriptions to generate alternative linguistic forms.

5. The computer-implemented method of claim 1, wherein generating the plurality of scene descriptions comprises generating structured descriptions that specify scene content in a machine-readable format.

6. The computer-implemented method of claim 1, wherein generating the training dataset comprises associating each scene description included in the plurality of scene descriptions with an image frame depicting a corresponding simulated scene included in the plurality of simulated scenes.

7. The computer-implemented method of claim 1, wherein the training dataset includes both natural-language and structured descriptions corresponding to each simulated scene included in the plurality of simulated scenes.

8. The computer-implemented method of claim 1, wherein the training dataset is formatted in a data structure compatible with a vision-language model.

9. The computer-implemented method of claim 1, wherein the physics-based simulation environment simulates interactions among multiple objects governed by physical laws.

10. The computer-implemented method of claim 1, wherein training the at least one physical reasoning model comprises fine-tuning a pre-trained vision-language model using the training dataset.

11. The computer-implemented method of claim 10, wherein fine-tuning the pre-trained vision-language model comprises minimizing a loss function that quantifies a difference between model-generated scene descriptions and the plurality of scene descriptions associated with the training dataset.

12. One or more non-transitory computer readable media storing instructions that, when executed by one or more processors, cause the one or more processors to generate training data for physical reasoning models, by performing the operations of:
obtaining simulation annotations generated by a physics-based simulation environment for a plurality of simulated scenes;
generating a plurality of scene descriptions based on the simulation annotations;
generating a training dataset by combining the plurality of scene descriptions with corresponding visual data depicting the plurality of simulated scenes; and
training at least one physical reasoning model using the training dataset to generate at least one trained physical reasoning model.

13. The one or more non-transitory computer readable media of claim 12, wherein the at least one trained physical reasoning model is configured to generate physical reasoning outputs in response to visual inputs depicting real-world scenes.

14. The one or more non-transitory computer readable media of claim 12, wherein the simulation annotations are generated automatically by executing scripted scenarios within the physics-based simulation environment.

15. The one or more non-transitory computer readable media of claim 12, wherein the simulation annotations comprise structured data that includes at least one of object identifiers, object properties, or temporal parameters associated with the plurality of simulated scenes.

16. The one or more non-transitory computer readable media of claim 12, wherein generating the plurality of scene descriptions comprises generating natural-language descriptions from the simulation annotations.

17. The one or more non-transitory computer readable media of claim 16, further comprising rephrasing the natural-language descriptions to generate alternative linguistic forms.

18. The one or more non-transitory computer readable media of claim 12, wherein generating the plurality of scene descriptions comprises generating structured descriptions that specify scene content in a machine-readable format.

19. The one or more non-transitory computer readable media of claim 12, wherein generating the training dataset comprises associating each scene description included in the plurality of scene descriptions with an image frame depicting a corresponding simulated scene included in the plurality of simulated scenes.

20. A computer system, comprising:
one or more memories that include instructions; and
one or more processors that are coupled to the one or more memories and, when executing the instructions, are configured to generate training data for physical reasoning models, by performing the operations of:
obtaining simulation annotations generated by a physics-based simulation environment for a plurality of simulated scenes;
generating a plurality of scene descriptions based on the simulation annotations;
generating a training dataset by combining the plurality of scene descriptions with corresponding visual data depicting the plurality of simulated scenes; and
training at least one physical reasoning model using the training dataset to generate at least one trained physical reasoning model.
